(19) United States
(12) Patent Application Publication
(10) Pub. No.: US 2024/0128601 A1
(43) Pub. Date: Apr. 18, 2024

(54) ELECTRODE PIECE, ROLLED CORE AND BATTERY

(71) Applicant: ZHUHAI COSMX BATTERY CO., LTD., Zhuhai (CN)

(72) Inventors: Changzhi OU, Zhuhai (CN); Chong Peng, Zhuhai (CN); Yan Xu, Zhuhai (CN); Fangjun Jiang, Zhuhai (CN)

(21) Appl. No.: 18/399,276

(22) Filed: Dec. 28, 2023

Related U.S. Application Data
(63) Continuation of application No. PCT/CN2022/131176, filed on Nov. 10, 2022.

(30) Foreign Application Priority Data
Dec. 30, 2021 (CN) 202123412174.3

(51) Int. Cl. H01M 50/533; H01M 10/04; H01M 50/538

(52) U.S. Cl. CPC H01M 50/533; H01M 10/0431; H01M 50/538

(57) ABSTRACT

An electrode piece, a rolled core and a battery, where the electrode piece includes a current collector and an active substance layer; the electrode piece has a single-sided area and a double-sided area, the single-sided area is located on a side of the electrode piece along a length direction thereof, a surface of one side of the current collector in the single-sided area is covered with the active substance layer, while surfaces of both sides of the current collector in the double-sided area are covered with the active substance layer; and multiple tabs protrude from one side of the electrode piece along a width direction thereof, and are spaced apart; in the single-sided area, an anti-rolling strip is provided on a surface of a side of the current collector not covered by the active substance layer, and is disposed on the same side as the tabs.

### CROSS-REFERENCE TO RELATED APPLICATION

This application is a continuation of International Application No. PCT/CN2022/131176, filed on Nov. 10, 2022, which claims priority to Chinese Patent Application No. 202123412174.3, filed on Dec. 30, 2021 with China National Intellectual Property Administration. Both of the aforementioned applications are hereby incorporated by reference in their entireties.

### TECHNICAL FIELD

The present application relates to the technical field of battery, in particular to an electrode piece, rolled core, and battery.

### BACKGROUND

The rolled core of a battery with large charge and discharge rates is usually a multi-tab structure. The rolled core of the multi-tab structure includes a positive electrode piece, a negative electrode piece and a separator, where the positive electrode piece, the separator and the negative electrode piece are laminated together and rolled up along their own length directions to form the rolled core, where multiple tabs protrude from a side edge of the positive electrode piece and the negative electrode piece along length directions thereof.

At present, for the rolled core of multi-tab structure, the positive and negative electrode pieces thereof have a single-sided area. The single-sided area refers to that one side of the electrode piece is coated and the other side thereof is not coated. Due to difference in tension between the coated layer and the uncoated layer of the single-sided area, the single-sided area will be rolled after the electrode piece is cut off. If the single-sided area is provided with the tab, the tab in the single-sided area is easily folded, causing problems such as short circuit and poor appearance of the battery. Therefore, the single-sided area of the electrode piece is usually not provided with the tab.

However, due to absence of tab in the single-sided area, the single-sided area has greater impedance than other areas of the electrode piece, resulting in uneven current distribution of the electrode piece and exacerbating the risk of lithium precipitation in the single-sided area.

### SUMMARY

The present application provides an electrode piece, a rolled core and a battery for solving the problem of exacerbating the risk of lithium precipitation in the single-sided area of the electrode piece of the existing battery due to inability to set the tab in the single-sided area can thus easily caused uneven current distribution of the electrode piece.

The present application provides an electrode piece, which includes a current collector and an active substance layer;
the electrode piece has a single-sided area and a double-sided area, the single-sided area is located on a side of the electrode piece along a length direction thereof, a surface of one side of the current collector in the single-sided area is covered with the active substance layer, and surfaces of both sides of the current collector in the double-sided area are covered with the active substance layer; and
multiple tabs protrude from one side of the electrode piece along a width direction thereof, the multiple tabs are spaced apart, and the tabs are provided on both the single-sided area and the double-sided area, where in the single-sided area, an anti-rolling strip is provided on a surface of a side of the current collector not covered with the active substance layer, and the anti-rolling strip and the tabs are disposed on the same side.

The electrode piece provided by the present application includes a current collector and an active substance layer, where the active substance layer covers a surface of the current collector, and the area with the active substance layer only on a surface of one side of the current collector is called a single-sided area, the area with the active substance layer on surfaces of both sides of the current collector is called a double-sided area, and the single-sided area is located on a side of the electrode piece along a length direction thereof. Multiple tabs protrude from a side of the electrode piece along a width direction thereof, the tabs protrude from both the single-sided area and the double-sided area of the electrode piece, moreover, an anti-rolling strip is provided on a surface of a side of the current collector not covered with the active substance layer, and the anti-rolling strip and the tabs are disposed on the same side, the anti-rolling strip can balance tensions of surfaces of two sides of the current collector at a place where the tab is located and improve a rolling degree of the single-sided area of the electrode piece, to prevent the tab in the single-sided area from being folded; after the single-sided area is provided with the tab, the current generated in the single-sided area can be directly conducted to the positive and negative electrodes of the battery through the tab of the single-sided area, and does not need to be conducted through an adjacent tab of the double-sided area, so that a load of the adjacent tab can be reduced and uneven current distribution of the electrode piece can be effectively improved, improving a lithium precipitation situation in the single-sided area.

In one implementation, along the width direction of the electrode piece, an edge of one side of the anti-rolling strip is flush with edge of a side of the current collector provided with the tabs.

In one implementation, a thickness of the anti-rolling strip is smaller than a thickness of the active substance layer.

In one implementation, a width of the anti-rolling strip is greater than or equal to 1/10 of a width of the current collector.

In one implementation, along the length direction of the electrode piece, a projection of the anti-rolling strip in a thickness direction of the electrode piece at least covers a position corresponding to the tab on the single-sided area and an area between the tab and a junction of the double-sided area and the single-sided area.

In one implementation, along the length direction of the electrode piece, two ends of the anti-rolling strip are respectively flush with two ends of the single-sided area.

In one implementation, the anti-rolling strip is an adhesive tape or a ceramic coating.

In one implementation, along the length direction of the electrode piece, the electrode piece includes multiple folded sections provided in sequence, where each two folded sections have one tab protruded therefrom; alternatively, each folded section has one tab protruded therefrom.

The present application provides a rolled core, including a separator and an electrode piece, where the electrode piece includes a first electrode piece and a second electrode piece; the first electrode piece, the separator and the second electrode piece are laminated in sequence and rolled together along the length direction of the electrode piece;
where at least one of the first electrode piece and the second electrode piece is any one of the above electrode pieces.

The rolled core provided by the present application includes a separator and an electrode piece, where the electrode piece includes a positive electrode piece and a negative electrode piece, the electrode piece includes a current collector and an active substance layer, the active substance layer covers a surface of the current collector; and the positive electrode piece, the separator and the negative electrode piece are laminated in sequence and rolled together along a length direction of the electrode piece, so that a content of the active substance layer per unit volume can be increased, to increase energy density of the rolled core and improve the performance of the battery. Where, an area with the active substance layer only on a surface of one side of the current collector is called a single-sided area, an area with the active substance layer on surfaces of both sides of the current collector is called a double-sided area, and the single-sided area is located on a side along the length direction of the electrode piece; multiple tabs protrude from a side of the electrode piece along a width direction thereof, the tabs protrude from both the single-sided area and the double-sided area, and moreover, an anti-rolling strip is provided on a surface of a side of the current collector not covered with the active substance layer, and the anti-rolling strip and the tabs are disposed on the same side, the anti-rolling strip can balance tensions of surfaces of two sides of the current collector at a place where the tab is located and improve the rolling degree of the single-sided area of the electrode piece, to prevent the tab in the single-sided area from being folded; after the single-sided area is provided with the tab, the current generated in the single-sided area can be directly conducted to the positive and negative electrodes of the battery through the tab of the single-sided area, and does not need to be conducted through an adjacent tab of the double-sided area, so that a load of the adjacent tab can be reduced and uneven current distribution of the electrode piece can be effectively improved, improving a lithium precipitation situation in the single-sided area.

In an implementation mode, the first electrode piece of the rolled core is any one of the above electrode pieces; the second electrode piece of the rolled core includes multiple folded sections provided in sequence, and surfaces of both side of the folded sections are covered with the active substance layer.

The present application also provides a battery, which includes a shell, electrolyte and the above rolled core, where the rolled core is located in the shell, and the electrolyte is injected into the shell installed with the rolled core.

For the battery, shell, electrolyte and the rolled core provided by the present application, the rolled core is located in the shell, and the electrolyte is injected into the shell where the rolled core is installed, the rolled core includes a separator and an electrode piece, the electrode piece is in contact with the electrolyte and converts a chemical energy in the electrolyte into an electrical energy, a current generated on the electrode piece can be conducted to the positive and negative electrodes on the shell through the tabs on it. Where, the electrode piece has a single-sided area and a double-sided area, and both the double-sided area and the single-sided area are provided with the tab, and in the single-sided area on the electrode piece, an anti-rolling strip is provided on a surface of a side of the current collector not covered by the active substance layer, and the anti-rolling strip and the tabs are disposed on the same side, the anti-rolling strip can balance the tensions of surfaces of two sides of the current collector at a place where the tab is located and improve the rolling degree of the single-sided area of the electrode piece, to prevent the tab in the single-sided area from being folded; after the single-sided area is provided with the tab, the current generated in the single-sided area can be directly conducted to the positive and negative electrode pieces of the battery through the tab of the single-sided area and uneven current distribution of the electrode piece can be effectively improved, improving a lithium precipitation situation in the single-sided area.

The structure of the present application, as well as other inventive objects and beneficial effects thereof, will be more clearly and easily understood by describing the embodiments in conjunction with the accompanying drawings.

### BRIEF DESCRIPTION OF DRAWINGS

By referring to the following detailed description of the accompanying drawings, the above and other objectives, features and advantages of the present application embodiments will become easier to be understood. In the accompanying drawings, multiple embodiments of the present application will be explained in an exemplary and non-restrictive manner.

FIG. 1 is a schematic diagram of an electrode piece in the prior art.

FIG. 2 is a schematic diagram of an electrode piece according to an embodiment of the present application.

FIG. 3 is a schematic diagram of a cross-section taken along a-a in FIG. 2.

FIG. 4 is a schematic diagram of another electrode piece according to an embodiment of the present application.

FIG. 5 is a schematic diagram of a rolled core with separator being hidden according to an embodiment of the present application.

FIG. 6 is a schematic diagram of a positive electrode piece in FIG. 5.

FIG. 7 is a schematic diagram of a negative electrode piece in FIG. 5.

The reference signs in the accompanying drawings:
100—electrode piece; 101—positive electrode piece; 102—negative electrode piece; 110—current collector; 111—tab; 120—active substance layer; 130—anti-rolling strip; and A—single-sided area; B—double-sided area.

### DESCRIPTION OF EMBODIMENTS

The following will describe the embodiments of the present application in detail, examples of the embodiments are shown in the accompanying drawings, where the same or similar signs throughout the accompanying drawings represent the same or similar components or components with the same or similar functions. The embodiments described below with reference to the accompanying drawings are exemplary and intended to explain the present application, but cannot be understood as limiting the present application.

The rolled core of a battery with large charge and discharge rates is usually a multi-tab structure. The rolled core of the multi-tab structure includes a positive electrode piece, a negative electrode piece and a separator, where the positive electrode piece, the separator and the negative electrode piece are laminated together and rolled up along their own length directions to form a rolled core, where multiple tabs protrude from a side edge of the positive electrode piece and the negative electrode piece along length directions thereof.

FIG. 1 is a schematic diagram of an electrode piece in the prior art. As shown in FIG. 1, in a rolled core with a multi-tab structure, an electrode piece 01 usually includes a single-sided area 02 and a double-sided area 03, and both the positive electrode piece and the negative electrode piece have the single-sided area 02. The single-sided area 02 refers to that one side of the electrode piece is coated and the other side is uncoated. Due to difference in tension between the coated surface and the uncoated surface of the single-sided area 02, rolling of the single-sided area 02 will occur after the electrode piece is cut off. If a tab 04 is provided in the single-sided area 02, the tab 04 of the single-sided area 02 will be easily folded, resulting in short circuit and poor appearance of the battery. Therefore, the single-sided area 02 of the electrode piece is usually not provided with the tab 04.

However, due to that there is no tab in the single-sided area, the single-sided area has greater impedance than other areas of the electrode piece, resulting in uneven current distribution of the electrode piece and exacerbating the risk of lithium precipitation in the single-sided area.

In view of this, the present application provides an electrode piece, the electrode piece includes a current collector and an active substance layer, the electrode piece has a single-sided area and a double-sided area, both the single-sided area and the double-sided area have a tab, a current generated in the single-sided area can be directly conducted to the positive and negative electrodes of the battery through the tab of the single-sided area, effectively improving uneven current distribution of the electrode piece and improving a lithium precipitation situation in the single-sided area; furthermore, an anti-rolling strip is provided on a surface of a side of the current collector not covered by the active substance layer, to prevent the tab in the single-sided area from being folded.

The following provides a detailed explanation of the electrode piece, rolled core and battery provided in the embodiments of the present application in conjunction with the accompanying drawings.

### Embodiment 1

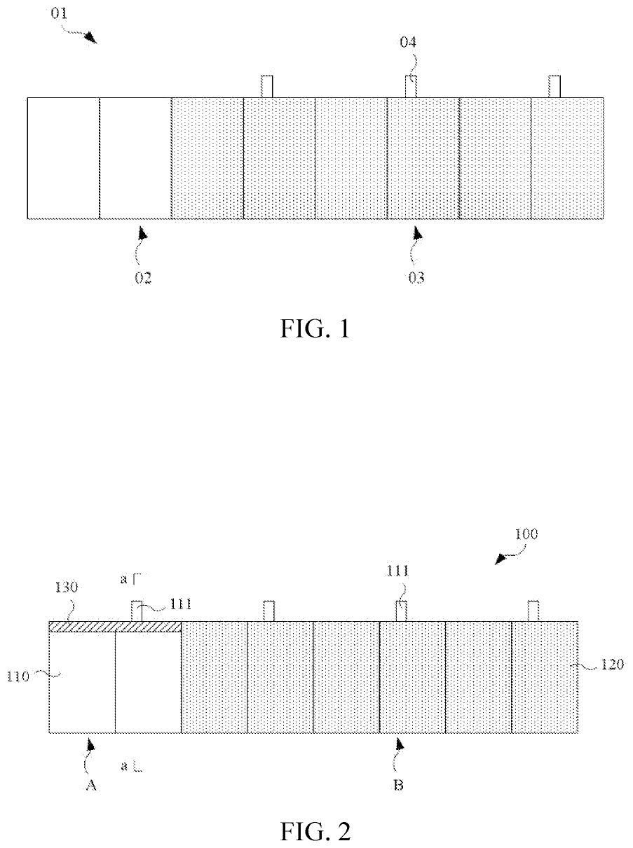

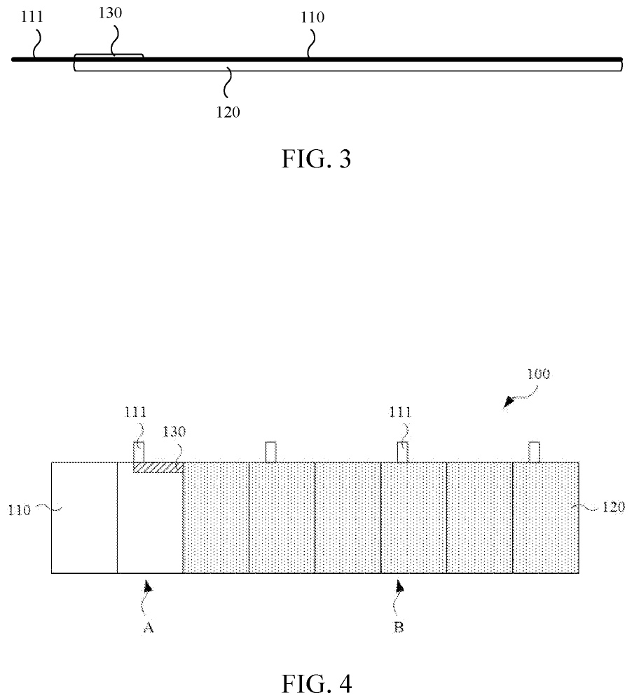

FIG. 2 is a schematic diagram of an electrode piece 100 according to an embodiment of the present application; FIG. 3 is a schematic diagram of a cross-section taken along a-a in FIG. 2. As shown in FIGS. 2 and 3, the present application provides an electrode piece 100, which can be applied in a battery. Specifically, the electrode piece 100 can be a positive electrode piece 101 or a negative electrode piece 102, and the positive electrode piece 101, the negative electrode piece 102 and the separator together form a battery cell.

The electrode piece 100 includes a current collector 110 and an active substance layer 120, multiple tabs 111 protrude from a side of the electrode piece 100 along a width direction thereof, the multiple tabs are spaced apart.

Where the active substance layer 120 contains an active substance for, the active substance is used to generate an electric current. The current collector 110 refers to a structure or component for collecting the current, and is generally a metal foil such as copper foil and aluminum foil, and a main function of the current collector 110 is to collect the current generated by the active substance in the active substance layer 120, to form a larger current for output to outside. The tab 111 protruding from the electrode piece 100 is formed by die-cutting of the electrode piece 100, and specifically, the tab 111 is formed by die-cutting an area of the current collector 110 where the active substance layer 120 is not provided, and a main function of the tab 111 is to conduct the current collected on the current collector 110 outward.

As shown in FIG. 2, the electrode piece 100 has a single-sided area A and a double-sided area B. The single-sided area A is located on a side of the electrode piece 100 along a length direction thereof, a surface of a side of the current collector 110 in the single-sided area A is covered with the active substance layer 120, and surfaces of both side of the current collector 110 in the double-sided area B are covered with the active substance layer 120.

In addition, along the length direction of the electrode piece 100, the electrode piece 100 includes multiple folded sections disposed in sequence, each two folded sections forming one circle of the rolled core, the single-sided area A occupies two folded sections, and the double-sided area B occupies 5-40 folded sections. The double-sided area B shown in FIG. 2 is provided with six folded sections. In other examples, the double-sided area b can also be provided with 10 or 25 folded sections, the more folded sections there are in the double-sided area B, the greater the capacity of the battery.

Exemplarily, each two folded sections have one tab 111 protruded therefrom, or each folded section has one tab 111 protruded therefrom, to increase a magnitude of the current when the battery is charging and discharging and improve the rate of battery.

If there is no single-sided area A and only the double-sided area B are provided with the tabs, the tabs 111 will not be easily folded. However, in two folded sections of an innermost layer of the rolled core, the polarities of the active substance layers 120 in the innermost layer are the same, and in two folded sections of an outermost layer of the roll core, the active substance layer 120 in the outermost layer does not have an active substance layer 120 of opposite polarity to its counterpart, the volume of the rolled core is increased and the energy density of the rolled core is decreased, affecting the performance of the battery and also causing a waste of material used in the active substance layer 120. Therefore, setting the single-sided zone A can increase the energy density of the rolled core and improve the performance of the battery, and also avoid causing a waste of the used material to save cost, and thus is very necessary.

Although setting the single-sided area A has many advantages, the single-sided area A of the electrode piece 100 is more prone to lithium precipitation. In practical applications, when the battery is charging, lithium ions are de-intercalated from the positive electrode piece 101 and then intercalated into the negative electrode piece 102 through the separator, completing the conversion of electrical energy to chemical energy. However, when some abnormal conditions occur and cause the lithium ions de-intercalated from the positive electrode piece 101 to be unable to be intercalated into the negative electrode piece 102, the lithium ions can only precipitate on the surface of the negative electrode piece 102, forming a layer of gray material. This phenomenon is called lithium precipitation.

For example, when an uneven current distribution occurs in the electrode piece 100 of the battery, it will lead to a situation where the negative electrode piece 102 has insufficient local residual capacity, and the lithium ions that can be intercalated in the negative electrode piece 102 are less than the lithium ions that are de-intercalated from the positive electrode piece 101, and the lithium ions that cannot be intercalated in the negative electrode piece 102 can only precipitate on the surface of the negative electrode piece 102. Lithium precipitation not only reduces the performance of the battery and significantly shortens the cycle life thereof, but also limits a fast charging capacity of the battery and may cause catastrophic consequences such as combustion and explosion.

In order to improve the lithium precipitation situation of the electrode piece 100, the tab 111 can be die-cut in the single-sided area A of the electrode piece 100. In the present embodiment, both the single-sided area A and the double-sided area B of the electrode piece 100 have the tab 111. After the single-sided area A is provided with the tab 111, the current generated in the single-sided area A can be directly conducted to the positive and negative electrodes of the battery through the tab 111 of the single-sided area A, and there is no need to conduct the current through an adjacent tab 111 of the double-sided area B, so that a load of the adjacent tab 111 can be reduced and uneven current distribution on the electrode piece 100 can be effectively improved, and thus the lithium precipitation situation in the single-sided area A can also be improved, avoiding occurrence of the above problem.

Since surfaces of both sides of the current collector 110 in the single-sided area A have different tensions and are easy to roll up, the tab 111 in this area is easy to be folded. In order to avoid the tab 111 protruding out of the single-sided area A from being folded, in the single-sided area A in this embodiment, an anti-rolling strip 130 is provided on a surface of a side of the current collector 110 not covered by the active substance layer 120, and the anti-rolling strip 130 and the tab 111 are disposed on the same side, as shown in FIG. 2, the anti-rolling strip 130 is located on a side of the current collector 110 close to the tab 111. The anti-rolling strip 130 can balance the tensions of surfaces of two sides of the current collector 110 at a place where the tab 111 is located, increase thickness and tension of a surface of a side of the electrode piece 100 not covered with the active substance layer 120, and decrease a tension difference between the surface of the side of the electrode piece 100 not covered with the active substance layer 120 and a surface of a side covered with the active substance layer 120, which can improve the rolling degree of the electrode piece 100 in the single-sided area A to prevent the tab 111 in the single-sided area A from being folded.

Exemplarily, along the width direction of the electrode piece 100, an edge of a side of the anti-rolling strip 130 can be flush with an edge of a side of the current collector 110 provided with the tabs 111, and the anti-rolling strip 130 abuts against the tab 111 on the single-sided area A, so as to balance the tensions of surfaces of two sides at the edge of the current collector 110 in the single-sided area A and better prevent the rolling of the single-sided area A of the electrode piece 100 from affecting the tab 111. In addition, an edge of the electrode piece 100 near a side where the tab 111 is located is thinned, and the edge of the electrode piece 100 is easy to be adhered, the existence of the anti-rolling strip can compensate for the thickness of the edge of the electrode piece 100 to a certain extent, and improve the interface adhesion at the end of the rolled core. Moreover, the anti-rolling strip 130 is used to supplement the thinned edge of the electrode piece 100, and can also reduce the increase of the thickness of the rolled core formed by the rolling of the electrode piece 100 and reduce the influence of the anti-rolling strip 130 on the energy density of the rolled core.

When implemented, a thickness of the anti-rolling strip 130 can be less than or equal to a thickness of the active substance layer 120. Specifically, the thickness of the anti-rolling strip 130 can be set to 30-100 μm, for example, the thickness of anti-rolling strip 130 can be set to 50 μm, 65 μm or 80 μm, and the thickness of the anti-rolling strip can be controlled while ensuring the anti-rolling effect, to reduce the volume of the electrode piece 100 after rolling, reduce the volume and weight of the battery, increase the energy density of the battery, improving performance of the battery.

In addition, a width of the anti-rolling strip 130 can be greater than or equal to 1/10 of a width of the current collector 110 to ensure the anti-rolling effect. Specifically, the width of the anti-rolling strip 130 can be set to 5-50 mm, for example, the thickness of the anti-rolling strip 130 can be 15 mm, 30 mm or 35 mm, which may save consumables, reduces costs and reduces the weight of the battery while ensuring the anti-rolling effect.

FIG. 4 is a schematic diagram of another electrode piece 100 according to an embodiment of the present application. As shown in FIG. 4, along a length direction of the electrode piece 100, a projection of the anti-rolling strip 130 in the thickness direction of the electrode piece 100 can at least cover a position corresponding to the tab 111 on the single-sided area A and an area between the tab 111 and a junction between the double-sided area B and the single-sided area A, which may save consumables and meanwhile ensure that the current collector 110 in the area where the tab 111 is located will not be rolled, to prevent the tabs 111 from being folded.

Alternatively, along the length direction of the electrode piece 100, the anti-rolling strip 130 can at least cover a side edge of one folded section in the whole single-sided area A; or as shown in FIG. 2, along the length direction of the electrode piece 100, two ends of the anti-rolling strip 130 can be respectively flush with two ends of the single-sided area A, that is, the anti-rolling strip 130 can cover the whole side edge of the single-sided area A, so as to further ensure that the current collector 110 on a side where the tab 111 is located will not be rolled, to improve the anti-rolling effect.

Specifically, a length of the anti-rolling strip can be set to 20-100 mm, for example, the length of the anti-rolling strip can be set to 35 mm, 55 mm or 80 mm, etc.

It should be noted that the numerical values and numerical ranges involved in the embodiments of the present application are approximate values, and may be have a certain range of errors due to the influence of the manufacturing process, but the errors is negligible to the skilled in the art.

In an actual production, the anti-rolling strip 130 can be an adhesive tape or a ceramic coating, where the ceramic coating is formed by applying a ceramic coating material to a surface of the current collector 110. Both the adhesive tape and the ceramic coating are insulators, and thus do not affect the current collector 110. Moreover, the adhesive tape and the ceramic coating do not react with an electrolyte, and thus do not affect an electrolytic reaction and the performance of the battery.

In order to explain improvement of the lithium precipitation phenomenon of the battery by the size of the anti-rolling strip 130, the present embodiment shows an example of a control experiment, and the control experiment includes four experimental groups and one control group, the control group and the experimental groups are identical in variables, such as the size of the electrode piece 100, except for whether the single-sided area A is provided with the tab 111 and also the setting of the anti-rolling strip 130. the control group and the experimental groups are specifically set as follows:
Experimental group 1: a single-sided area A of an electrode piece 100 is provided with an adhesive tape with a thickness of 40 μm, a width of 10 mm and a length of 50 mm, and the single-sided area A is provided with a tab 111;
Experimental group 2: the single-sided area A of the electrode piece 100 is provided with an adhesive tape with a thickness of 30 μm, a width of 5 mm and a length of 100 mm, and the single-sided area A is provided with a tab 111;
Experimental group 3: the single-sided area A of the electrode piece 100 is provided with an adhesive tape with a thickness of 40 μm, a width of 10 mm and a length of 20 mm, and the single-sided area A is provided with the tab 111;
Experimental group 4: the single-sided area A of the electrode piece 100 is provided with a ceramic coating with a thickness of 40 μm, a width of 10 mm and a length of 30 mm, and the single-sided area A is provided with the tab 111;
Control group: the single-sided area A of the electrode piece 100 is not provided with both an anti-rolling strip 130 and the tab 111.

The following performance tests were carried out on the batteries prepared in the above groups, where the test process was as follows.

Firstly, a DCR (Direct Current Resistance) test was conducted, where DCR impedance values of the batteries of the experimental groups and the control group were tested using a direct current impedance meter at 25° C.

Then, the batteries of the experimental and control groups were placed in an environment at 25° C., and were charged to 4.45V at a constant current rate of 1.5C, and then they were charged at a constant voltage of 4.45V, and the charging was stopped when the current was 0.025C. After that, the batteries were discharged at a constant current rate of 0.5C, and the discharging was stopped when the voltage was 3V. This is a charging and discharging cycle, which was repeated for 1000 times.

Finally, the batteries were fully charged, and disassembled in a dry environment, to observe the lithium precipitation situation on the surface of the single-sided area A of the negative electrode piece 102.

TABLE 1
The lithium precipitation situation of experimental
groups and the control group

| | DCR impedance | Lithium precipitation |
|---|---|---|
| Group | values/mΩ | situation |
| Experimental group 1 | 6.0 | No lithium precipitation |
| Experimental group 2 | 6.1 | No lithium precipitation |
| Experimental group 3 | 6.0 | No lithium precipitation |
| Experimental group 4 | 6.1 | No lithium precipitation |
| Control group | 6.5 | Slight lithium |
| | | precipitation |

It can be seen from Table 1 that within the size ranges of the anti-rolling strips 130 given in the embodiments of the present application, the single-sided areas A all can be successfully provided with the tab 111, and the electrode pieces 100 with the single-sided areas A provided with the tab 111 have reduced DCR impedance values, and the lithium precipitation situation in the single-sided areas A of the electrode pieces 100 is obviously improved. In addition, the ceramic coating and the adhesive tape have similar effects and almost the same DCR impedance value; and both of them are insulated and do not react with the electrolyte, not affecting the performance of the batteries.

### Embodiment 2

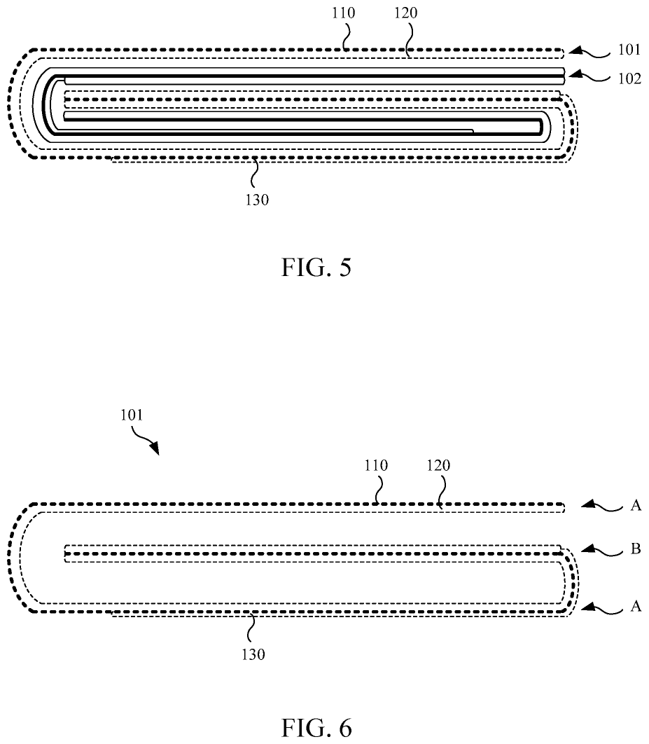

FIG. 5 is a schematic diagram of a rolled core with separator being hidden according to an embodiment of the present application. As shown in FIG. 5, the present application also provides a rolled core, which includes a separator (not shown) and an electrode piece 100, where the electrode piece 100 includes a first electrode piece and a second electrode piece, where the first electrode piece can be a positive electrode piece 101, and in this case, the second electrode piece is a negative electrode piece 102; or the first electrode piece can be a negative electrode piece 102, and in this case, the second electrode piece is a positive electrode piece 101.

In the rolled core, the positive electrode piece 101, the separator and the negative electrode piece 102 are laminated in sequence and rolled together along the length direction of the electrode piece 100, where at least one of the positive electrode piece 101 and the negative electrode piece 102 is the electrode piece 100 provided in the Embodiment 1.

As shown in FIG. 4 and FIG. 5, the electrode piece 100 includes a current collector 110 and an active substance layer 120 for covering a surface of the current collector 110, where an area where a surface of only one side of the current collector 110 is provided with the active substance layer 120 is called a single-sided area A, and an area where surfaces of both sides of the current collector 110 are provided with the active substance layer 120 is called a double-sided area B. The single-sided area A is located on a side of the electrode piece 100 along a length direction thereof, multiple tabs 111 protrude from a side of the electrode piece 100 along a width direction thereof, the multiple tabs 111 protrude from both the single-sided area A and the double-sided area B of the electrode piece 100.

Moreover, the surface of one side of the current collector 110 not covered with the active substance layer 120 is provided with an anti-rolling strip 130, the anti-rolling strip 130 is disposed on the same side as the tab 111, the anti-rolling strip 130 can balance the tensions of surfaces of two sides of the current collector 110 at a place where the tab 111 is located, improve the rolling degree of the electrode piece 100 in the single-sided area A, to prevent the tab 111 in the single-sided area A from being folded. After the single-sided area A is provided with the tab 111, the current generated in the single-sided area A can be directly conducted to the positive and negative electrodes of the battery through the tab 111 in the single-sided area A, and does not need to be conducted through an adjacent tab 111 in the double-sided area B, so that a load of the adjacent tab 111 can be reduced and uneven current distribution on the electrode piece 100 can be effectively improved, and thus the lithium precipitation situation in the single-sided area A is improved.

It should be noted that when the first electrode piece is the electrode piece 100 provided in Embodiment 1, the second electrode piece can also be provided with the same number of tabs 111, and the second electrode piece includes multiple folded sections provided in sequence, and in order to prevent the tabs 111 from being folded, surfaces of both sides of the folded sections can be covered with the active substance layer, for example, the single-sided area A of the positive electrode piece 101 in the outer layer of the rolled core in FIG. 5 can also be coated with the active substance layer 120, so that all the folded sections on the electrode piece 100 can be provided as the double-sided area B. Alternatively, both the first electrode piece and the second electrode piece can be the electrode piece 100 provided in Embodiment 1, so as to save the consumables of the active substance layer 120, increase the energy density of the rolled core, improving the performance of the battery.

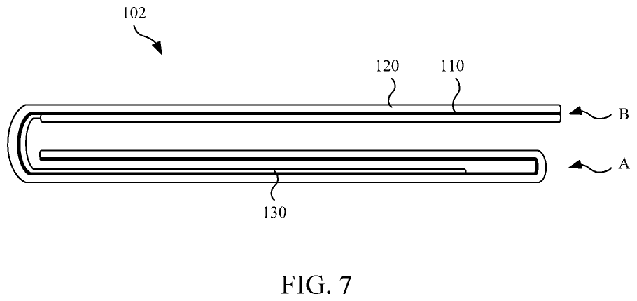

FIG. 6 is a schematic diagram of a positive electrode piece in FIG. 5; FIG. 7 is a schematic diagram of a negative electrode piece in FIG. 5. As shown in FIGS. 5-7, when both the positive electrode piece 101 and the negative electrode piece 102 are the electrode piece 100 provided in Embodiment 1, the single-sided area A of the negative electrode piece 102 can be provided in an inner layer of the rolled core, and the single-sided area A of the positive electrode piece 101 can be provided in an outer layer of the rolled core. In other examples, the single-sided area A of the positive electrode piece 101 may be provided in an inner layer of the rolled core, and the single-sided area A of the negative electrode piece 102 may be provided in an outer layer of the rolled core.

In addition, the structure, function and working principle of the electrode piece 100 have been introduced in detail in Embodiment 1, and will not be repeated here.

### Embodiment 3

The embodiment of the present application provides a battery, which includes a shell, an electrolyte and the rolled core provided by Embodiment 2, where the rolled core is located in the shell, and the electrolyte is injected into the shell installed with the rolled core. Exemplarily, the battery can be a lithium-ion battery, and in other examples, the battery can also be other types of batteries such as lead-acid batteries, nickel-hydrogen batteries, nickel-cadmium batteries and the like.

Where the rolled core includes a separator and an electrode piece 100, the electrode piece 100 is in contact with the electrolyte and converts an chemical energy in the electrolyte into an electrical energy, a current generated on the electrode piece 100 can be conducted to positive and negative electrodes on the shell through the tabs 111 thereon.

The electrode piece 100 has a single-sided area A and a double-sided area B, both the double-sided area B and the single-sided area A are provided with the tab 111. After the tab 111 is provided in the single-sided area A, the current generated in the single-sided area A can be directly conducted to the positive and negative electrodes of the battery through the tab 111 of the single-sided area A, which can effectively improve the uneven current distribution on the electrode piece 100 and the precipitation situation in the single-sided area A. Furthermore, in the single-sided area A on the electrode piece 100, an anti-rolling strip 130 is provided on a surface of a side of the current collector 110 not covered by the active substance layer 120, to prevent short circuit and poor appearance of the battery due to folding of the tab 111 in the single-sided area A.

In a specific embodiment, a manufacturing process of the battery is as follows.

Firstly, 1.8 wt % of conductive carbon black and 1.3 wt % of polyvinylidene fluoride (PVDF) are added to 96.9 wt % of lithium cobaltate and N-methylpyrrolidone (NMP) is added, to form a positive electrode active substance slurry, then the positive electrode active substance slurry is coated on a surface of a positive electrode current collector 110 by a coating device, followed by drying, rolling, slicing and flaking to obtain a positive electrode piece 101, and multiple tabs 111 are cut during die cutting.

Then, an artificial graphite as negative electrode active substance, a conductive carbon black as conductive agent, and styrene butadiene rubber (SBR)+sodium carboxymethyl cellulose (CMC) as adhesive, are mixed at a ratio of 96.9 wt %, 0.5 wt %, 1.3 wt %+1.3 wt %, respectively, and after mixing, deionized water is added for dispersion, to form a negative electrode active substance slurry with an appropriate solid content, the negative electrode active substance slurry is then coated on a negative electrode current collector 110 through a coating device, followed by drying, rolling, slicing and flaking to obtain a negative electrode piece 102, and multiple tabs 111 are cut during die cutting.

Next, an adhesive tape or a ceramic coating is applied to an edge of a side where the tabs 111 are located on single-sided areas A of the positive electrode piece 101 and the negative electrode piece 102.

After the positive electrode piece 101 and the negative electrode piece 102 are prepared, the positive electrode piece 101, a separator, and the negative electrode piece 102 are laminated in sequence together and rolled to form a rolled core, the rolled core is then packaged with an aluminum plastic film to form a battery cell, which is subjected to liquid injection, aging, formation, secondary packaging and other process to obtain a battery, finally, electrochemical performances of the battery are tested.

In addition, the structures, functions and working principles of the electrode pieces 100 are described in detail in Embodiment 1, and will not be repeated here.

In the description of the present specification, orientations or positional relationships indicated by the terms “length”, “width”, “thickness”, etc. are based on the orientations or positional relationships shown in the accompanying drawings, they are only intended to facilitate the description of the present application and simplify the description, and not to indicate or imply that the mentioned devices or components must have a specific orientation, or be constructed and operated in a specific orientation, and thus they cannot be understood as limitations of the present application.

It should be understood that a description with reference to the terms such as “embodiment” or “example” means that a specific feature, structure, material or characteristic described in connection with this embodiment or example is included in at least one embodiment or example of the present application. In this specification, the schematic expressions of the above terms are not necessarily directed to the same embodiment or example. Moreover, the specific features, structures, materials or characteristics described may be combined in any one or more embodiments or examples in a suitable manner. In addition, the skilled in the art can incorporate and combine different embodiments or examples and features in different embodiments or examples described in this specification without contradicting each other.

Finally, it should be noted that the above embodiments are only used to illustrate the technical solutions of the present application, but not to limit them; although the present application has been described in detail with reference to the aforementioned embodiments, it should be understood by the skilled in the art that the technical solutions described in the aforementioned embodiments can still be modified, or some or all of technical features therein can be replaced equivalently; and these modifications or replacements do not make the essence of the corresponding technical solutions deviate from the scope of the technical solutions of the embodiments of the present application.

What is claimed is:

1. An electrode piece, comprising a current collector and an active substance layer,
the electrode piece has a single-sided area and a double-sided area, the single-sided area is located on a side of the electrode piece along a length direction of the electrode piece, a surface of one side of the current collector in the single-sided area is covered with the active substance layer, and surfaces of both sides of the current collector in the double-sided area are covered with the active substance layer;
multiple tabs protrude from a side of the electrode piece along a width direction of the electrode piece, the multiple tabs are spaced apart, and both the single-sided area and the double-sided area are provided with the tab; wherein, in the single-sided area, an anti-rolling strip is provided on a surface of a side of the current collector not covered with the active substance layer, and the anti-rolling strip and the tab are disposed on the same side.

2. The electrode piece according to claim 1, wherein, along the width direction of the electrode piece, an edge of one side of the anti-rolling strip is flush with an edge of one side of the current collector provided with the tab.

3. The electrode piece according to claim 1, wherein a thickness of the anti-rolling strip is less than or equal to a thickness of the active substance layer.

4. The electrode piece according to claim 1, wherein a width of the anti-rolling strip is greater than or equal to 1/10 of a width of the current collector.

5. The electrode piece according to claim 1, wherein, along the length direction of the electrode piece, a projection of the anti-rolling strip in a thickness direction of the electrode piece at least covers a position corresponding to the tab on the single-sided area and an area between the tab and a junction of the double-sided area and the single-sided area.

6. The electrode piece according to claim 2, wherein, along the length direction of the electrode piece, a projection of the anti-rolling strip in a thickness direction of the electrode piece at least covers a position corresponding to the tab on the single-sided area and an area between the tab and a junction of the double-sided area and the single-sided area.

7. The electrode piece according to claim 3, wherein, along the length direction of the electrode piece, a projection of the anti-rolling strip in a thickness direction of the electrode piece at least covers a position corresponding to the tab on the single-sided area and an area between the tab and a junction of the double-sided area and the single-sided area.

8. The electrode piece according to claim 4, wherein, along the length direction of the electrode piece, a projection of the anti-rolling strip in a thickness direction of the electrode piece at least covers a position corresponding to the tab on the single-sided area and an area between the tab and a junction of the double-sided area and the single-sided area.

9. The electrode piece according to claim 1, wherein, along the length direction of the electrode piece, two ends of the anti-rolling strip are respectively flush with two ends of the single-sided area.

10. The electrode piece according to claim 2, wherein, along the length direction of the electrode piece, two ends of the anti-rolling strip are respectively flush with two ends of the single-sided area.

11. The electrode piece according to claim 3, wherein, along the length direction of the electrode piece, two ends of the anti-rolling strip are respectively flush with two ends of the single-sided area.

12. The electrode piece according to claim 4, wherein, along the length direction of the electrode piece, two ends of the anti-rolling strip are respectively flush with two ends of the single-sided area.

13. The electrode piece according to claim 5, wherein the anti-rolling strip is an adhesive tape or a ceramic coating.

14. The electrode piece according to claim 9, wherein the anti-rolling strip is an adhesive tape or a ceramic coating.

15. The electrode piece according to claim 5, wherein, along the length direction of the electrode piece, the electrode piece comprises multiple folded sections provided in sequence, wherein each two folded sections have one tab protruded therefrom, or each folded section has one tab protruded therefrom.

16. The electrode piece according to claim 9, wherein, along the length direction of the electrode piece, the electrode piece comprises multiple folded sections provided in sequence, wherein each two folded sections have one tab protruded therefrom, or each folded section has one tab protruded therefrom.

17. A rolled core, comprising a separator and an electrode piece, wherein the electrode piece comprises a first electrode piece and a second electrode piece, the first electrode piece, the separator and the second electrode piece are laminated in sequence and rolled together along the length direction of the electrode piece;
wherein at least one of the first electrode piece and the second electrode piece is the electrode piece according to claim 1.

18. The rolled core according to claim 17, wherein, along the width direction of the electrode piece, an edge of one side of the anti-rolling strip is flush with an edge of one side of the current collector provided with the tab.

19. A rolled core, comprising a separator and an electrode piece, wherein the electrode piece comprises a first electrode piece and a second electrode piece, the first electrode piece, the separator and the second electrode piece are laminated in sequence and rolled together along the length direction of the electrode piece;
wherein the first electrode piece is the electrode piece according to claim 1;
the second electrode piece comprises the multiple folded sections provided in sequence, surfaces of both sides of the folded sections are covered with the active substance layer.

20. A battery, comprising a shell, an electrolyte and the rolled core according to claim 17, wherein the rolled core is located in the shell, and the electrolyte is injected into the shell with the rolled core.
